(19) United States
(12) Patent Application Publication
(10) Pub. No.: US 2018/0246267 A1
(43) Pub. Date: Aug. 30, 2018

(54) BACKLIGHT MODULE, DISPLAY DEVICE TO WHICH BACKLIGHT MODULE IS APPLIED, AND METHOD FOR MANUFACTURING LIGHT GUIDE PLATE

(71) Applicants: HKC Corporation Limited, Shenzhen City, Guangdong (CN); Chongqing HKC Optoelectronics Technology Co., Ltd., Chongqing (CN)

(72) Inventor: Chia-Hang LEE, Chongqing (CN)

(21) Appl. No.: 15/561,758

(22) PCT Filed: May 19, 2017
(86) PCT No.: PCT/CN2017/085153

§ 371 Date: Sep. 26, 2017

(30) Foreign Application Priority Data
Dec. 31, 2016 (CN) 201611268466.5

(51) Int. Cl. F21V 8/00

(52) U.S. Cl. CPC G02B 6/0035; G02B 6/0065; G02B 6/0061

(57) ABSTRACT

A backlight module includes a light source, using a blue light-emitting diode as an excitation light source; and an LGP, including a bottom surface and a plurality of dots arranged two-dimensionally. The dots are located on the bottom surface, each dot includes a quantum dot (QD) material, and the QD material is screen-printed on the bottom surface of the LGP; by means of a distribution of dots on the LGP, a line light source of the backlight module is uniformly converted into an area light source. The LGP has a mixture of a QD material and a printing solvent, and designed dot positions are distributed on one side of the LGP by using a dot manufacturing technological process, so as to complete the LGP with a light-emitting characteristic of the QD material.

### BACKGROUND

### Technical Field

This application relates to a display manner of using quantum dots, and in particular, to a backlight module, a display device to which the backlight module is applied, and a method for manufacturing a light guide plate (LGP).

### Related Art

A quantum dot is a nano crystal with a diameter equal to or less than 10 nanometers (nm), is composed of a semiconductor material, and can cause a quantum confinement effect. As compared with typical phosphor, a quantum dot generates denser light on a narrower band. When an excited electron is transmitted from a conduction band to a valence band, a quantum dot emits light and has a characteristic that even if materials are the same, a light wavelength changes according to particle sizes. Because the light wavelength changes according to a size of the quantum dot, light having a required wavelength area may be obtained by controlling the size of the quantum dot.

A quantum dot enhancement film (QDEF) is an optical component that is currently used on a backlight module and that is configured to enable presentation of a color of a display to be more precise. A principle is that two types of quantum dots with equivalent quantities are disposed on the film, and blue light is used as a backlight source; when irradiating on the two types of quantum dots, the blue light is separately converted into red light and green light, and the generated red light, the generated green light, and the blue light are mixed into white light; a color mixing effect can be closer to an actual color by changing a proportion of the blue light converted into the red light to the blue light converted into the green light. Therefore, presentation of the color of the display is more precise.

Therefore, in order to meet higher requirements of human eyes on a displayed color, a wide color gamut is currently one of projects to be urgently developed in display technologies. A quantum dot (QD for short below) display is a display manner for extending a color gamut of a display. Because of a characteristic of a narrower light-emitting wavelength, a display using a QD light-emitting material technology usually has a wider displayed color gamut as compared with a conventional display. Generally, a displaying performance for which a QD technology is used may achieve a gamut objective that a gamut area is greater than that of 100% NTSC. Therefore, a design manner of how to use a QD material to achieve high efficiency and high productivity is one of current important issues.

### SUMMARY

To resolve the foregoing technical problem, an objective of this application is to provide a display manner for which QDs are used, and in particular, relates to a backlight module, a display device to which the backlight module is applied, and a method for manufacturing an LGP. No optical component needs to be added to an original LCD display. Therefore, an original module design manner is not affected. Moreover, no additional component costs are required for improving original dot distribution materials of the light guide plate and introducing a QD material as an excitation light source. The total reflection principle of the LGP may be used to repeatedly excite the QD material so as to increase red light and green light conversion efficiency.

The following technical solutions are used to achieve the objective of this application and resolve the technical problem of this application. A backlight module provided in this application includes: a light source used a blue light-emitting diode as an excitation light source; and an LGP, comprising a bottom surface and a plurality of dots arranged two-dimensionally, where the dots are located on the bottom surface, each dot comprises a QD material, and the QD material is screen-printed on the bottom surface of the LGP; by means of a distribution of dots on the LGP, a line light source of the backlight module is uniformly converted into an area light source.

The following technical measures may be used to further achieve the objective of this application and resolve the technical problem of this application.

A method for manufacturing an LGP is provided, where the LGP has a mixture of a QD material and a printing solvent, and designed dot positions are distributed on one side of the LGP by using a dot manufacturing technological process, so as to complete the LGP with a light-emitting characteristic of the QD material.

A display device is provided, comprising the backlight module, and a display panel configured to display images.

In an embodiment of this application, blue light excited by the light source has a wavelength in a range of 435 nm to 470 nm.

In an embodiment of this application, in the light guide plate, the density of dots decreases in a direction towards the light source, and the density of dots increases in a direction away from the light source.

In an embodiment of this application, the QD material comprises a yellow QD material and a green QD material.

In an embodiment of this application, each dot further comprises a barrier adhesive, configured to seal the QD material.

In an embodiment of this application, the QD material is a QD material of a III-V family or a QD material of a II-VI family.

In an embodiment of this application, the material of the printing solvent is ink or another material that can be used for screen printing.

In an embodiment of this application, printed dots are in a distribution design in which the blue light incident from a side surface can be uniformly distributed as a planar light source by means of an optical simulation process.

In an embodiment of this application, the LGP is of a cuboid shape.

In this application, no optical component needs to be added to an original LCD display. Therefore, an original module design manner is not affected. Moreover, no additional component costs are required for improving original dot distribution materials of the LGP and introducing a QD material as an excitation light source. The total reflection principle of the LGP may be used to repeatedly excite the QD material so as to increase red light and green light conversion efficiency.

### BRIEF DESCRIPTION OF THE DRAWINGS

FIG. 1a is a display diagram of light intensity of a band of light emitted by an exemplary QD;

FIG. 1b is a schematic diagram of an exemplary QD tube;

FIG. 1c is a schematic diagram of an exemplary QD film;

FIG. 2 is a schematic diagram of an optical design of an LGP using a QD material according to an embodiment of this application;

FIG. 3 is a display diagram of a light source spectrum of white light that has red, green, and blue of high color saturation and that is excited and converted by using a blue light source according to an embodiment of this application;

FIG. 4 is a schematic diagram of a printed dot design manner according to an embodiment of this application;

FIG. 5 is an architecture diagram of a display with an LGP according to an embodiment of this application;

FIG. 6 is a schematic diagram of an LGP according to an embodiment of this application; and

FIG. 7 is a schematic diagram of an LGP with a QD material according to an embodiment of this application.

### DETAILED DESCRIPTION

The following embodiments are described with reference to the accompanying drawings, which are used to exemplify specific embodiments for implementation of this application. Terms about directions mentioned in this application, such as “on”, “below”, “front”, “back”, “left”, “right”, “in”, “out”, and “side surface” merely refer to directions of the accompanying drawings. Therefore, the used terms about directions are used to describe and understand this application, and are not intended to limit this application.

The accompanying drawings and the description are considered to be essentially exemplary, rather than limitative. In the drawings, units with similar structures are represented by using a same numeral. In addition, for understanding and ease of description, a size and a thickness of each component shown in the accompanying drawings are arbitrarily shown, but this application is not limited thereto.

In the accompanying drawings, for clarity, thicknesses of a layer, a film, a panel, an area, and the like are enlarged. In the accompanying drawings, for understanding and ease of description, thicknesses of some layers and areas are enlarged. It should be understood that when a component, for example, a layer, a film, an area, or a substrate is described as “being located” “on” another component, the component may be directly on the another component, or there is a middle component.

In addition, in the specification, unless clearly described as an opposite meaning, a word “include” is understood as including the component but not excluding any other components. In addition, in the description, “being located on . . . ” indicates being located above or below a target component, but does not indicate having to be located on the top based on a gravity direction.

To further describe the technical means adopted in this application to achieve the preset invention objective and effects thereof, specific implementations, structures, features, and effects of a backlight module, a display device to which the backlight module is applied, and a method for manufacturing an LGP that are provided in this application are described in detail below with reference to the accompanying drawings and preferred embodiments.

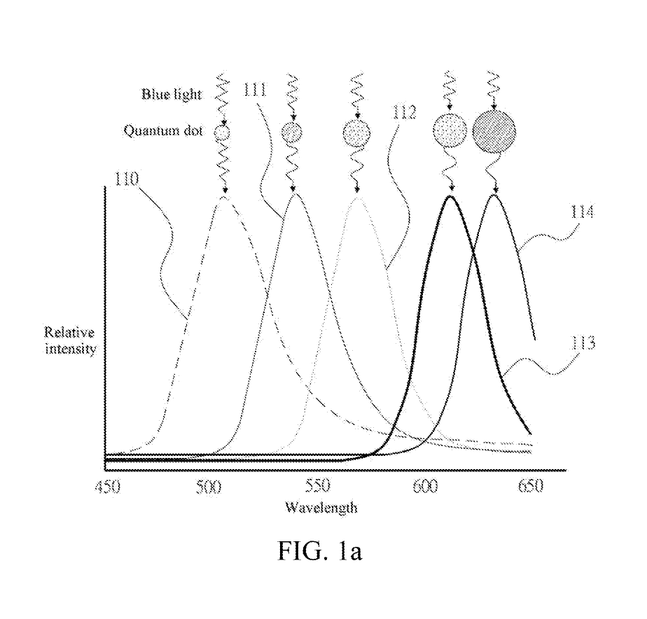

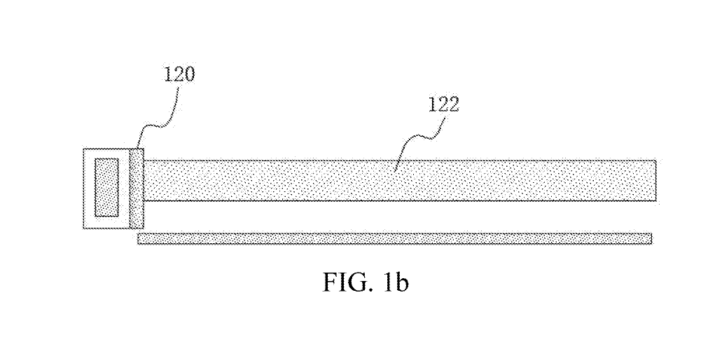

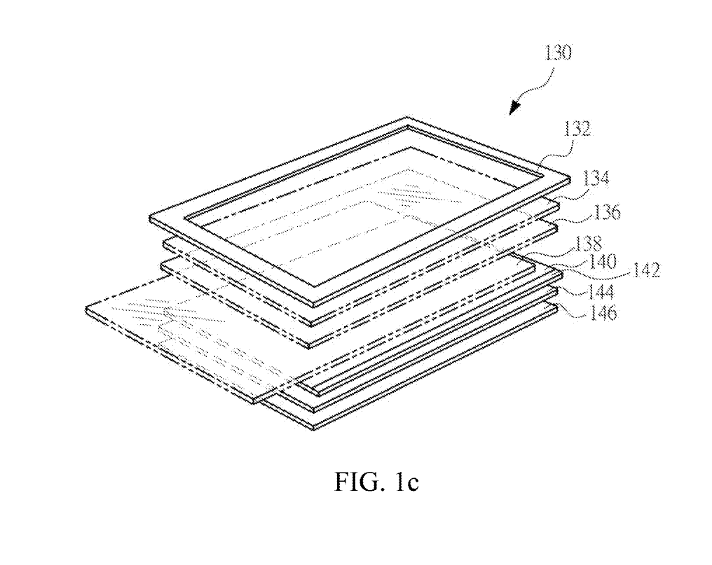

FIG. 1a is a display diagram of light intensity of a band of light emitted by an exemplary QD, FIG. 1b is a schematic diagram of an exemplary QD tube, and FIG. 1c is a schematic diagram of an exemplary QD film. Referring to FIG. 1a, in order to meet higher requirements of human eyes on a displayed color, a wide color gamut is currently one of projects to be urgently developed in display technologies. A QD display is a display manner for extending a color gamut of a display. A display using a QD light-emitting material technology usually has a characteristic of a narrower light-emitting wavelength (such as wavelengths 110, 111, 112, 113, and 114 in FIG. 1a).

Referring to FIG. 1b and FIG. 1c, currently, methods for reaching requirements of a wide color gamut display by using a QD technology are approximately divided into the following two technologies. One technology is a QD tube technology, that is, a QD material is encapsulated in a glass tube 122, and a blue light-emitting diode 120 is used as a light source for exciting the QD material (as shown in FIG. 1b). After the blue light excites the QD material, an electron dot emits a light with a red and green spectrum, and white light with a three-color (red, green, and blue) spectrum can be obtained. The other QD technology is referred to as a QD film technology. The QD film technology, just as its name implies, is that a QD material is sealed in a film material, like a sandwich structure, an upper layer and a lower layer are protection layer films, and the QD material is placed therebetween (as shown in FIG. 1c). When a blue light-emitting diode is incident on the QD film, the QD material in the QD film is excited, and emits a red and green light spectrum, so as to achieve an objective of generating a white light source.

Referring to FIG. 1c, an existing backlight module 130 includes: a backplane 146, a baffle 132 connected to the backplane 146 and surrounding together with the backplane 146 to form accommodation space, an LGP 140 disposed in the accommodation space, a QDEF 138 disposed on the surface of the LGP 140 and located in the accommodation space, a light-emitting diode blue light source 142 disposed in the accommodation space, a reflecting element 144 disposed on the bottom surface of the LGP 140, and a plurality of optical films 134 and 136 superposed with each other on the LGP 140. Light emitted by a light source of the backlight module 130 is transmitted by the LGP 140. By means of reflection functions of the optical films 134 and 136, when penetrating through the QDEF 138 from the LGP 140, the light may be reflected and then penetrate through the QDEF 138 again. The light penetrates through the QDEF 138 by means of many times of refraction, generates correction light by means of a light mixing function, and then penetrates through the optical films 134 and 136 again. In addition, when passing by the LGP 140 and being reflected by the reflecting element 144, the light goes back to the LGP 140, is refracted again, and penetrates through the QDEF 138 to generate the correction light.

Both of the two design manners of the QD display have defects. To avoid a problem that the QD material may be invalid in a water vapor environment, the QD tube technology is usually used as a backlight source of the display. However, as stated above, two times of light conversion are required for the QD tube (light of the light-emitting diode to the surface of the QD tube, and from the surface of the QD tube to the LGP). Therefore, light efficiency conversion has a poor effect. In addition, the tube is on the appearance of the display. Because of one extra tube, a narrow bezel cannot be designed for the structure, and the QD tube is hardly to be universally popularized on the current market. In addition, if the design manner of the QD film is used, because water vapor cannot be completely and effectively isolated in a film encapsulation manner, even if there is a colloid surrounding the QD film to isolate the water vapor, there are still invalid areas (that is, in the invalid areas, the QD material cannot be excited). Moreover, for excitation efficiency of the QD on the blue-light light-emitting diode, because there is only an excitation process of “a one-time optical path”, light-emitting efficiency is lower. Therefore, generally, a film material, that is, a double brightness enhanced film (DBEF) needs to be used together, so that the blue light may go back and forth between a reflecting film and the DBEF, and continuously excite the QD material to obtain a design of high light-emitting efficiency. However, the DBEF is needed for the design manner, and design costs of the display greatly increases. Therefore, the design manner is not widely used.

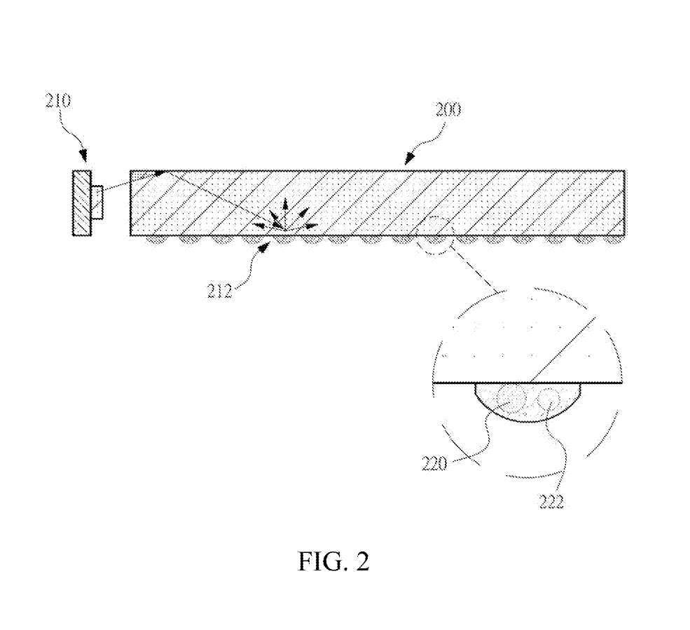

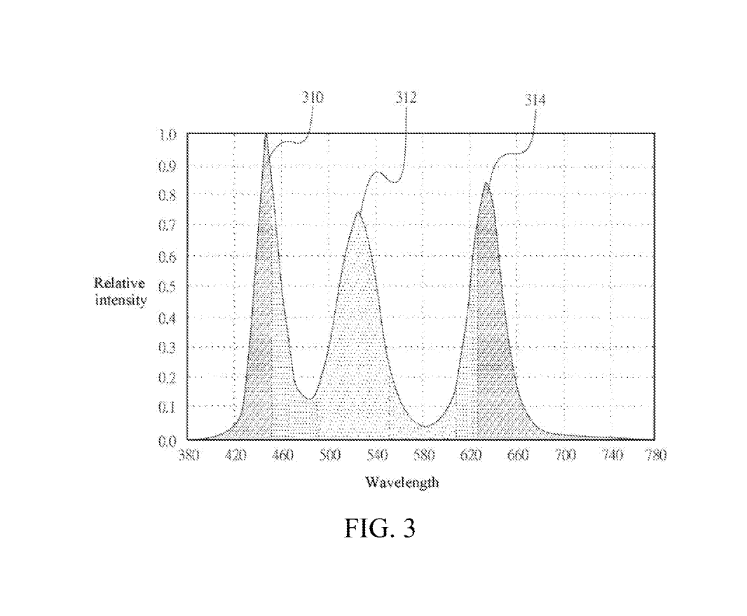

FIG. 2 is a schematic diagram of an optical design of an LGP using a QD material according to an embodiment of this application, and FIG. 3 is a display diagram of a light source spectrum of white light that has red, green, and blue of high color saturation and that is excited and converted by using a blue light source according to an embodiment of this application. Referring to FIG. 2 and FIG. 3, in an embodiment of this application, this application mainly provides an optical design method using a QD material, including distributing a QD material on one side of an LGP 200, guiding a blue light-emitting diode light source 210 into the LGP 200 by using a characteristic of the LGP 200, and by means of particular distribution of dots 212 on the LGP 200, uniformly converting a line light source of the blue-light light-emitting diode into an area light source, as shown in FIG. 2. It can be known from FIG. 2 that the light-emitting diode blue light source 210 is located at the dots 212. Because the dots 212 damage the total reflection structure of the LGP 200, at the dots 212, the light-emitting diode blue light source 210 may be considered as a tiny light source, and the light-emitting diode blue light source 210 is converted into an area light source. QD particle materials 220 of red light and green light are coated at the dots 212 of the LGP 200. Therefore, a light source spectra (310, 312, 314) of white light that has red, green, and blue of high color saturation is converted by means of excitation of the blue light source 210, as shown in FIG. 3. In addition, the coated QD materials 220 are sealed in the dots 212 of the LGP 200 by using a barrier adhesive 222 that can isolate water vapor so as to form an LGP 200 that may have red and green narrow bands.

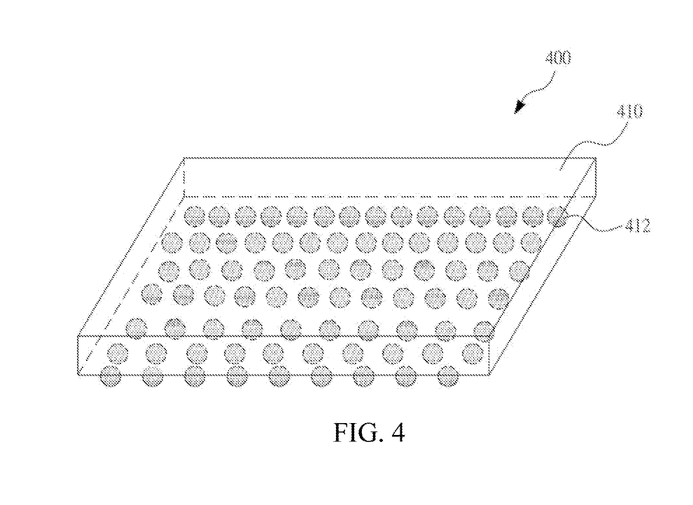

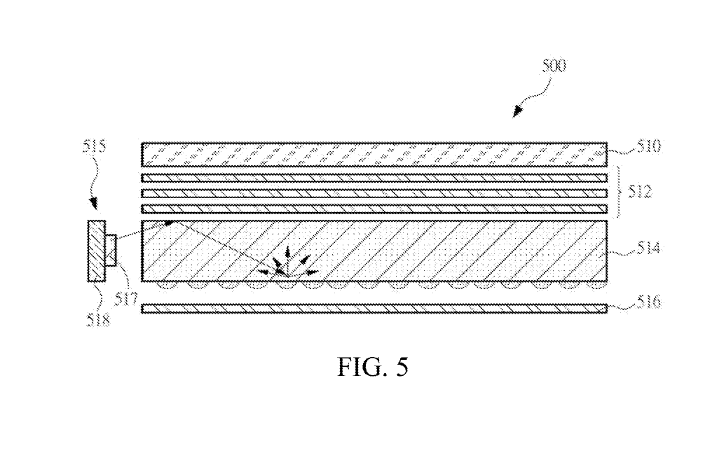

FIG. 4 is a schematic diagram of a printed dot design manner according to an embodiment of this application, and FIG. 5 is an architecture diagram of a display with an LGP according to an embodiment of this application. Referring to FIG. 4 and FIG. 5, in an embodiment of this application, an excitation light source 515 is required in this application, and is usually a blue-light light-emitting diode with a relatively short band. Generally, blue light with a band in a range of 430 nm to 470 nm is selected as the excitation light source 515. The excitation light source 515 is coupled to an LGP 514, and the material of the LGP 514 is usually PMMA or MS series. The thickness of the LGP 514 may be set according to the encapsulation size of the light-emitting diode. Currently, the mainstream thickness is 0.5 mm to 3.0 mm. Different designs are made according to different display sizes. Generally, a television with a relatively large size has an LGP having a thickness of more than 2.0 mm. Then, the selected bare printed dot LGP (without dots printed) includes a mixture of yellow and green QD materials and a printing solvent. Designed dot positions are distributed on one side of the LGP by using a dot manufacturing technological process, so as to complete the LGP with a light-emitting characteristic of the QD material. The QD material is a QD material of a III-V family or a QD material of a II-VI family. The material of the printing solvent is ink or another material that can be used for screen printing.

Referring to FIG. 2, FIG. 4, and FIG. 5, in an embodiment of this application, a method for manufacturing an LGP is provided. The LGP 514 has a mixture of a QD material 220 and a printing solvent, and designed positions of dots 412 are distributed on one side of the LGP 514 by using a dot manufacturing technological process, so as to complete the LGP 514 with a light-emitting characteristic of the QD material 220. The QD material 220 is a QD material 220 of a III-V family or a QD material 220 of a II-VI family. The material of the printing solvent is ink or another material that can be used for screen printing.

Referring to FIG. 4, in an embodiment of this application, printed dots 412 on the LGP 410 are in a distribution design in which the blue light incident from a side surface may be uniformly distributed as a planar light source by means of an optical simulation process.

Referring to FIG. 2, FIG. 4, and FIG. 5, in an embodiment of this application, a backlight module 400 includes a light source 515, an LGP 514, a light-emitting unit encapsulation element 518, and a QD sealing encapsulation element 517. The light source 515 uses a blue light-emitting diode as an excitation light source. The LGP 514 includes a bottom surface 410 and a plurality of dots 412 arranged two-dimensionally. These dots 412 are located on the bottom surface 410, each dot 412 includes a QD material 220, and the QD material 220 is screen-printed on the bottom surface 410 of the LGP 514; by means of a distribution of the dots 412 on the LGP 514, a line light source of the backlight module 400 is uniformly converted into an area light source. The light-emitting unit encapsulation element 518 includes a substrate and a plurality of light-emitting unit chips mounted on the substrate. The QD sealing encapsulation element 517 is disposed in a light-emitting direction of the light-emitting unit encapsulation element 518. The backlight module 400 is a blue light source of the light-emitting diode. Moreover, the density of the dots 412 decreases in a direction towards the blue light source of the light-emitting diode, and the density of the dots 412 increases in a direction away from the blue light source of the light-emitting diode. The QD material 220 includes a yellow QD material and a green QD material. Each dot 412 further includes a barrier adhesive 222, configured to seal the QD material 220.

In an embodiment of this application, the LGP is of a cuboid shape.

Referring to FIG. 5, in an embodiment of this application, a QD display 500 includes: an LGP 514, exciting red light and green light by using a light-emitting diode blue light source 515 and connected to an optical film 512 (such as a reflector sheet, a diffuser sheet, and a prism sheet); a reflector 516; and a display panel 510. Therefore, a display with high color saturation may be designed.

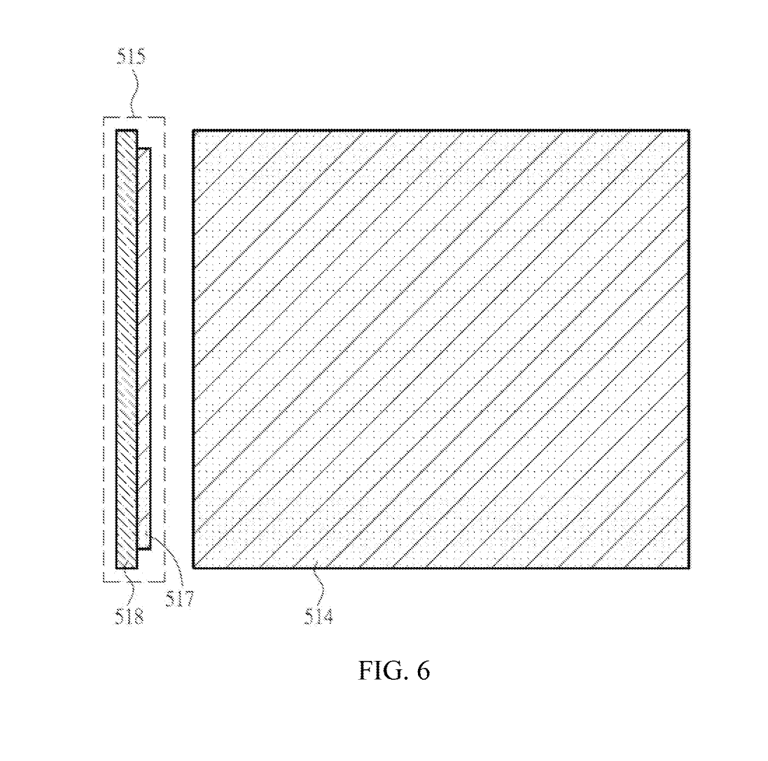

FIG. 6 is a schematic diagram of an LGP according to an embodiment of this application. Referring to FIG. 6, in an embodiment of this application, the QD sealing encapsulation element 517 is directly jointed with the light-emitting unit encapsulation element 518.

Referring to FIG. 6, in an embodiment of this application, the QD sealing encapsulation element 517 is a strip tube or a planar tube.

In an embodiment of this application, a plurality of light-emitting unit chips is aligned to a column or a plurality of columns.

In an embodiment of this application, the plurality of the light-emitting unit chips is arranged in a straight line, a curve, or a predetermined pattern.

In an embodiment of this application, the QD includes one of a nano crystal using silicone (Si) as a basis, a compound semiconductor nano crystal using a II-VI family as a basis, a compound semiconductor nano crystal using a III-V family as a basis, and a mixture thereof.

In an embodiment of this application, the plurality of light-emitting unit chips is light-emitting diode chips.

In an embodiment of this application, the substrate is a printed circuit board, and the plurality of light-emitting unit chips are directly mounted on the substrate.

In an embodiment of this application, the substrate is a printed circuit board. Each or a plurality of light-emitting unit chips is encapsulated into chip encapsulation elements, and the chip encapsulation elements are mounted on the substrate.

In an embodiment of this application, the plurality of light-emitting unit chips is blue light-emitting diode chips. The QD includes: a first QD, the size of which allowing a peak wavelength on a green light band; and a second QD, the size of which allowing a peak wavelength on a red light band.

In an embodiment of this application, blue light excited by the light source has a wavelength in a range of 435 nm to 470 nm

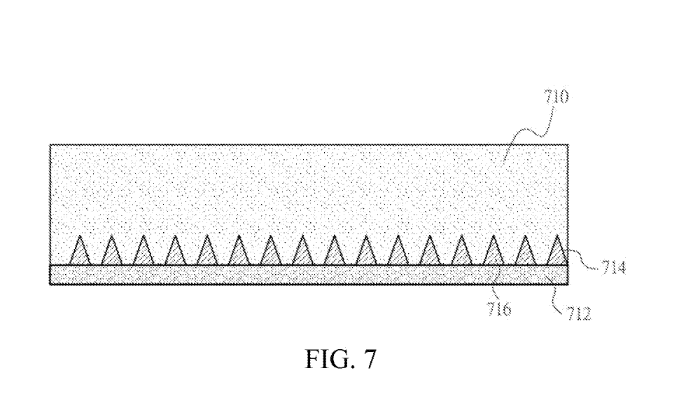

FIG. 7 is a schematic diagram of an LGP with a QD material according to an embodiment of this application. Referring to FIG. 7, in an embodiment of this application, an LGP 710 having a QD material includes a bottom surface 712 and a plurality of structural dots 714 arranged two-dimensionally. The structural dots 714 are located on the bottom surface 712, each structural dot 714 includes a QD material 716, and the QD material 716 is screen-printed on the bottom surface 712 of the LGP 710; by means of a distribution of the structural dots 714 on the LGP 710, a line light source of the backlight module is uniformly converted into an area light source.

A beneficial effect of this application is that no optical component needs to be added to an original LCD display. Therefore, an original module design manner is not affected. Moreover, no additional component costs are required for improving original dot distribution materials of the LGP and introducing a QD material as an excitation light source. The total reflection principle of the LGP may be used to repeatedly excite the QD material so as to increase red light and green light conversion efficiency.

Phases such as “in some embodiments” and “in various embodiments” are repeatedly used. The phases usually not refer to same embodiments, but the phases may refer to same embodiments. Words like “contain”, “have”, and “include” are synonyms, unless other meanings are indicated in the context of the words.

The foregoing descriptions are merely preferred embodiments of this application, and are not intended to limit this application in any form. Although this application has been disclosed above through the preferred embodiments, the embodiments are not intended to limit this application. Any person skilled in the art can make some equivalent variations or modifications according to the foregoing disclosed technical content without departing from the scope of the technical solutions of this application to obtain equivalent embodiments. Any simple amendment, equivalent change or modification made to the foregoing embodiments according to the technical essence of this application without departing from the content of the technical solutions of this application shall fall within the scope of the technical solutions of this application.

What is claimed is:

1. A backlight module, comprising:
a light source, using a blue light-emitting diode as an excitation light source; and
a light guide plate (LGP), comprising a bottom surface and a plurality of dots arranged two-dimensionally, wherein the dots are located on the bottom surface, each dot comprises a quantum dot (QD) material, and the QD material is screen-printed on the bottom surface of the LGP; by means of a distribution of dots on the LGP, a line light source of the light source is uniformly converted into an area light source.

2. The backlight module according to claim 1, wherein the excitation light source has a wavelength in a range of 435 nanometers (nm) to 470 nm.

3. The backlight module according to claim 1, wherein in the light guide plate, a density of dots decreases in a direction towards the light source, and the density of dots increases in a direction away from the light source.

4. The backlight module according to claim 1, wherein the QD material comprises a yellow QD material.

5. The backlight module according to claim 1, wherein the QD material comprises a green QD material.

6. The backlight module according to claim 1, wherein each dot further comprises a barrier adhesive, configured to seal the QD material.

7. A method for manufacturing a light guide plate (LGP), wherein the LGP has a mixture of a yellow and a green quantum dot (QD) material and a printing solvent, and designed dot positions are distributed on one side of the LGP by using a dot manufacturing technological process, so as to complete the LGP with a light-emitting characteristic of the QD material.

8. The method for manufacturing an LGP according to claim 7, wherein the QD material is a QD material of a III-V family.

9. The method for manufacturing an LGP according to claim 7, wherein the QD material is a QD material of a II-VI family.

10. The method for manufacturing an LGP according to claim 7, wherein the material of the printing solvent is ink or another material that can be used for screen printing.

11. The method for manufacturing an LGP according to claim 7, wherein printed dots are in a distribution design in which the blue light incident from a side surface can be uniformly distributed as a planar light source by means of an optical simulation process.

12. A display device, comprising a display panel configured to display images, and further comprising a backlight module, wherein the backlight module comprises:
a light source, using a blue light-emitting diode as an excitation light source; and
a light guide plate (LGP), comprising a bottom surface and a plurality of dots arranged two-dimensionally, wherein the dots are located on the bottom surface, each dot comprises a quantum dot (QD) material, and the QD material is screen-printed on the bottom surface of the LGP; by means of a distribution of dots on the LGP, a line light source of the light source is uniformly converted into an area light source;
the density of the dots is proportional to a distance between the dots and the light source; and
the LGP is of a cuboid shape.

13. The display device according to claim 12, wherein in the light guide plate, the density of dots decreases in a direction towards the light source.

14. The display device according to claim 12, wherein in the light guide plate, the density of dots increases in a direction away from the light source.

15. The display device according to claim 12, wherein the QD material comprises a yellow QD material.

16. The display device according to claim 12, wherein the QD material comprises a green QD material.
